(19) United States
(12) Patent Application Publication
(10) Pub. No.: US 2012/0119161 A1
(43) Pub. Date: May 17, 2012

(54) CATHODE ACTIVE MATERIAL FOR METAL-SULFUR BATTERY AND METHOD OF PREPARING THE SAME

(75) Inventors: Sam Ick Son, Seoul (KR); Hee Yeon Ryu, Uiwang (KR); Ki Chun Lee, Seoul (KR)

(73) Assignee: HYUNDAI MOTOR COMPANY, Seoul (KR)

(21) Appl. No.: 13/172,428

(22) Filed: Jun. 29, 2011

(30) Foreign Application Priority Data
Nov. 12, 2010 (KR) KR10-2010-0113034

(51) Int. Cl. H01B 1/24; H01M 4/04; B01J 8/00; H01M 4/587

(52) U.S. Cl. 252/506; 422/187

(57) ABSTRACT

A cathode active material for a metal-sulfur battery is provided. By using a cathode active material for a metal-sulfur battery comprising a sulfur-carbon composite composed of composited spherical sulfur compound particle and carbon material particle, electric conductivity of the cathode for a lithium-sulfur battery is increased to improve initial capacity close to theoretical capacity and polysulfide lost in the cathode during charging and discharging is minimized to increase sulfur utilization. Reaction between a metal anode and the polysulfide is minimized to increase life span and stability of the metal-sulfur battery.

### CROSS-REFERENCES TO RELATED APPLICATIONS

Priority is claimed to Korean patent application number 10-2010-0113034, filed on Nov. 12, 2010, the entire contents of which application is incorporated herein for all purposes by this reference.

### BACKGROUND OF THE INVENTION

1. Field of the Invention

The present invention relates to a cathode active material for a metal-sulfur battery, and more particularly, to a cathode active material for a metal-sulfur battery comprising a sulfur-carbon composite composed of composited spherical sulfur compound particle and carbon material particle.

2. Description of the Related Art

Metal-sulfur batteries, specifically, lithium-sulfur (Li—S) batteries are secondary batteries which use sulfur-based compounds having sulfur-sulfur (S—S) bonds (hereinafter, referred to as “sulfur compounds”) as cathode active materials and carbon-based materials in which insertion/intercalation of alkali metals such as lithium or metal ions such as lithium ions occurs as anode active materials.

The lithium-sulfur batteries store and generate electrical energy using an oxidation and reduction reaction such that in a reduction reaction, that is, in discharging, S—S bonds of the lithium-sulfur batteries are broken to reduce an oxidation number of sulfur and in an oxidation reaction, that is, in charging, an oxidation number of sulfur is increased to form S—S bonds again. Although these lithium-sulfur secondary batteries have a lower discharge potential of about 2V, they have good safety, discharge capacity of 2600 Wh/kg and volume capacity of 2760 Wh/l, and use cheap active materials so that many studies on the lithium-sulfur secondary batteries have been progressed as the next-generation secondary batteries following lithium ion batteries and lithium polymer batteries in recent years.

The lithium-sulfur secondary batteries using sulfur materials are disclosed in the following Patent Documents 1 to 7 and non-patent documents 1 to 8:
[Patent Document 1] M. Y. Chu, U.S. Pat. No. 5,814,420, Sep. 29, (1998);
[Patent Document 2] K. Naoi, T. Yamaguchi, A. Torikoshi, H. Iizuka, U.S. Pat. No. 5,792,575, Aug. 11, (1998);
[Patent Document 3] K. Naoi, H. Iizuka, Y. Suzuki, U.S. Pat. No. 5,723,230, Mar. 3, (1998);
[Patent Document 4] K. Naoi, H. Iizuka, Y. Suzuki, A. Torikoshi, U.S. Pat. No. 5,783,330, Jul. 21, (1998);
[Patent Document 5] K. Naoi, H. Iizuka, A. Torikoshi, Y. Suzuki, U.S. Pat. No. 5,882,819, Mar. 16, (1999);
[Patent Document 6] N. Oyama, K. Naoi, T. Sotomura, H. Uemachi, Y. Sato, T. Kanbara, K. Takeyama, U.S. Pat. No. 5,324,599, Jun. 28, (1994);
[Patent Document 7] M. Y. Chu, L. C. D. Jonghe, S. J. Visco, B. D. Katz, U.S. Pat. No. 6,030,720, Feb. 29, (2000);
[Non-Patent Document 1] J. Broadhead and T. Skotheim, The 15th International Seminar & Exhibit on Primary & Secondary Batteries, Florida, U.S.A., Mar. 2-5, (1998);
[Non-Patent Document 2] T. Sotomura, T. Tatsuma and N. Oyama, J. Electrochem. Soc., 143, 43 (1996);
[Non-Patent Document 3] N. Oyama, J. M. Pope, and T. Sotomura, J. Electrochem. Soc., 144, L47 (1997);
[Non-Patent Document 4] D. Linden, T. B. Reddy, Handbook of batteries, third ed., McGraw-Hill, New-York, (2001);
[Non-Patent Document 5] Xiulei Ji, Kyu Tae Lee and Linda F. Nazar, A highly ordered nanostructured carbon-sulfur cathode for lithium-sulfur batteries, NATURE MATERIALS VOL 8 JUNE (2009);
[Non-Patent Document 6] Sang-Eun Cheon, Ki-Seok Ko, Ji-Hoon Cho, Sun-Wook Kim, Eog-Yong Chin, and Hee-Tak Kim, Rechargeable Lithium Sulfur Battery, Journal of The Electrochemical Society, 150, Issue 6, pp. A800-A805 (2003);
[Non-Patent Document 7] V. S. Kolosnitsyn and E. V. Karaseva, Lithium-Sulfur Batteries: Problems and Solutions, Russian Journal of Electrochemistry, Vol. 44, No. 5, pp. 506-509 (2008); and
[Non-Patent Document 8] Yuan Yang, Matthew T. McDowell, Ariel Jackson, Judy J. Cha, Seung Sae Hong, and Yi Cui, New Nanostructured Li₂S/Silicon Rechargeable Battery with High Specific Energy, Nano Lett., 10 (4), pp. 1486-1491 (2010).

On the other hand, sulfurs have low electric conductivity and the sulfurs used for active materials form polysulfide in the charge and discharge reaction and are swept into an electrolyte so that the lithium-sulfur batteries have bad life characteristic. In addition, a passivation layer is formed on a surface of lithium metal to lower electrochemical activity so that the lithium-sulfur secondary batteries have bad cycle life and bad discharging potential characteristic in a high rate. Therefore, there are many problems to be solved for the lithium-sulfur secondary batteries to be commercialized.

More specifically, the lithium-sulfur batteries have high theoretical capacity of 1672 mAh/g on the basis of the sulfurs, but the sulfurs having electrical conductivity of 5×10⁻³⁰ S/cm which are active materials are close to non-conductors. Accordingly, the sulfurs with plenty of conductive materials are added in a cathode of the lithium-sulfur battery. In cathode composite materials consisting of sulfurs, conductive materials, binders, and additives, a ratio of the sulfurs is normally 50 to 60%. Out of the sulfurs which are active materials, a ratio of active sulfurs which contribute to a chemical reaction is normally 50 to 70%. Accordingly, considering the ratios of the conductive materials and the active sulfurs, usable capacity of the lithium-sulfur battery is only 30 to 40% of theoretical capacity.

In addition, S-S chemical bonds of the lithium-sulfur battery are gradually broken in discharging to be changed into S—Li bonds. In charging, a reverse reaction is progressed to change the S—Li bonds into the S—S bonds. Lithium polysulfide (Li₂Sₓ) formed in the intermediate procedure is diffusible in a form of LiSₓ or an anion of LiS_{X}⁻ or Sₓ⁻².

If lithium polysulfide is eluted and diffused from a sulfur cathode, the lithium polysulfide is deviated from an electrochemical reaction region so that an amount of sulfur involved in the reaction in the cathode is reduced and capacity loss is caused. Moreover, the elution of polysulfide increases viscosity of the electrolyte solution to reduce a life characteristic and increase electrical conductivity to have a bad effect on self discharging characteristic. In addition, the polysulfide and lithium metal are reacted by the continuous charging and discharging reaction and Li₂S is adhered to a surface of the lithium metal so that reaction activity becomes lowered and potential characteristic is degraded.

So as to solve the problem, as a method for delaying efflux of the cathode active material by adding, an additive for adsorbing the sulfur into the cathode composite material, there is a method of wrapping a cathode plate using active carbon fiber, transition metal chalcogenide having a highly porous, fibrous and ultra fine sponge like structure, or fine powders having strong adsorption such as alumina or silica. Alternatively, there is a method of staying polysulfide anions around cationic polymer by adding them into the cathode composite material and using the cationic polymer containing a quaternary ammonium salt group or of surface-treating a sulfur surface with hydroxide, oxyhydroxide, oxycarbonate, or hydroxycarbonate, or the like.

However, the method of adding the additive adsorbing sulfurs into the cathode has the problems of degradation of electrical conductivity and possibility of side effect due to the additive and is not the best solution in the aspect of cost.

Recently, the result of research was reported, which makes a carbon material used for a conductive material with a nano structure without adding an additive to improve electrical conductive network, thereby increasing electrical conductivity of the cathode and confines polysulfide into a capillary tube of the nano structure to localize soluble polysulfide during continuous charging and discharging around the cathode, thereby obtaining the usable capacity of the lithium-sulfur to theoretical capacity of 80%.

However, a method of fabricating a conductive material with a nano structure is complicated in a fabrication process, volume capacity loss of a battery is caused due to a volume occupied by the carbon nano structure, and the function of the nano structure may be lost in a rolling process of a battery fabrication procedure.

A particle composite fabrication technology of forming an inner core and an outer shell using a heterogeneous materials are technologies of fabricating single composite particles by compositing particles of submicron region with particles of a micron region with mixing and dispersing different kinds of particles by motion of a grinding material or a rotator within various fine grinding mill and improved apparatuses thereof. Since an apparent size of the particle is a size of a micron region and particles of the submicron region are dispersed and fixed on surfaces of micro particles, the fabrication technologies are capable of easily realizing a fabrication of new material expressing new function which is not acquired from a single component such as variation and control of flowability, electric characteristic, mechanical characteristic, and thermal characteristic.

Powder composition technologies are disclosed in the following non-patent documents 9 to 12:
[Non-Patent Document 9] M. Alonso, M. Satoh and K. Miyanami, Mechanism of the combined coating-mechanofusion processing of powder, Powder Technology, 59, 45-52 (1989);
[Non-Patent Document 10] M. Alonso, M. Satoh and K. Miyanami, Powder coating in a rotary mixer with rocking motion, Powder Technology, 56, 135-141 (1988);
[Non-Patent Document 11] Wenliang Chena, Rsjesh N. Dave, Robert Pfeffer, Otis Waltonb, Numerical Simulation of Mechanofusion System, Powder Technology, 146 121-136 (2004); and
[Non-Patent Document 12] Robert Pfeffer, Rsjesh N. Dave, Dongguang Wei, Michelle Ramlakhan, Synthesis of engineered particulates with tailored properties using dry particle coating, Powder Technology, 117 40-67 (2001).

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention have been made in view of the above problems, and provide a sulfur-carbon composite structure capable of increasing a ratio of a sulfur in a cathode of a lithium-sulfur battery by increasing electric conductivity of a sulfur electrode and preventing polysulfide formed in the cathode from losing out of a cathode reaction region, and a method of preparing the same.

According to an aspect of the present invention, a cathode active material for a metal-sulfur battery contains a sulfur-carbon composite composed of composited spherical sulfur compound particle and carbon material particle.

According to various aspects of a cathode active material for a metal-sulfur battery and a method of preparing the same of the present invention, conductivity of a cathode for a lithium-sulfur battery is increased to improve initial capacity close to theoretical capacity and amount of polysulfide lost in the cathode during charging and discharging is minimized to increase sulfur utilization. In addition, reaction between a lithium metal anode and the polysulfide is minimized to increase life span and stability of the lithium-sulfur battery.

The cathode active material and the preparing method thereof of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram illustrating a configuration of a sulfur-carbon composite according to the present invention.

FIG. 2 is a schematic diagram illustrating a polysulfide confined in a pore structure formed on a surface of a sulfur-carbon composite according to the present invention.

FIG. 3A is a schematic diagram illustrating a principle of a planetary rotor type applying shearing stress to a particle.

FIG. 3B is a schematic diagram illustrating a principle of a grinder type applying shearing stress to a particle.

FIG. 4 is a schematic diagram illustrating a lithium-sulfur battery using a sulfur-carbon composite as a cathode active material according to an embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In an exemplary embodiment of the present invention, a cathode active material for a metal-sulfur battery comprising a sulfur-carbon composite composed of composited spherical sulfur compound particle and carbon material particle is provided.

The metal-sulfur battery may include a lithium-sulfur battery. However, it need not be limited thereto and an alkali metal other than lithium may be used.

The sulfur compound may be a compound having sulfur-sulfur (S—S) bond and the carbon material may have a spherical shape or a fibrous shape and include carbon black, acetylene black, Ketjen black, or carbon fiber. The carbon fiber may include vapor grown carbon fiber (VGCF).

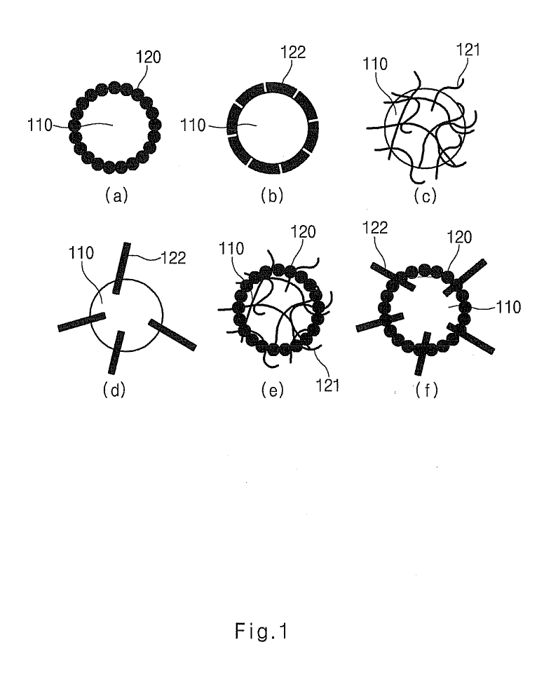

Referring to FIG. 1(a), (b), (c), and (d), the composite may have a configuration that spherical carbon materials 120 are coated and dispersed on a surface and inside of a sulfur compound particle 110 to be fixed thereto or that fibrous carbon materials 121 and 122 are inserted into the sulfur compound particle 110 to be fixed thereto. Alternatively, referring to FIG. 1(e) and (f), the composite may have a configuration that the spherical carbon materials 120 and the fibrous carbon materials 121 and 122 are mixed to be fixed to the surface and the inside of the sulfur compound particle 110.

As used herein, the “fixed” may be performed by adhering the carbon materials on the surface of the sulfur compound particle 110, by inserting the carbon materials into the sulfur compound particle, by fusing the carbon materials and the carbon compound particle, or by using a combination thereof.

The fusing step may be performed using a mechanofusion.

On the other hand, the spherical sulfur compound and the carbon material may satisfy all the following conditions (1) to (3):

Rs>10*Rc, (1)

As*Ws>Ac*Wc, and (2)

Wc/(Ws+Wc)=0.2˜0.25; (3)

wherein Rs represents a particle diameter (mm) of the sulfur compound,

Rc represents a particle diameter (nm) of the carbon material,

As represents a BET surface area (m²/g) of the sulfur compound,

Ac represents a BET surface area (m²/g) of the carbon material,

Ws represents an amount used (g) of the sulfur compound, and

We represents an amount used (g) of the carbon material.

In another exemplary embodiment of the present invention, a method of preparing a cathode active material for a metal-sulfur battery is provided and may comprise the following processes:

preparing a sulfur compound and a carbon material satisfying all the following conditions (1) to (3):

Rs>10*Rc, (1)

As*Ws>Ac*Wc, and (2)

Wc/(Ws+Wc)=0.2˜0.25; (3)

wherein Rs represents a particle diameter (mm) of the sulfur compound,

Rs represents a particle diameter (nm) of the carbon material,

As represents a BET surface area (m²/g) of the sulfur compound,

Ac represents a BET surface area (m²/g) of the carbon material,

Ws represents an amount used (g) of the sulfur compound, and

Wc represents an amount used (g) of the carbon material;

acid-treating the carbon material;

drying the sulfur compound and the acid-treated carbon material and obtaining sulfur compound powder and carbon material powder from which moisture is removed; and

mixing the sulfur compound powder and carbon material powder and compositing the mixed sulfur compound powder and carbon material powder by applying shearing stress to obtain a sulfur-carbon composite.

The acid-treating the carbon material may comprise putting the carbon material in an acid solution, stirring the acid solution at a temperature of 60 to 80° C. for 0.5 to 2 hours, vacuum filtering the solution, washing the filtered carbon material by distilled water several times, and drying the washed carbon material using a vacuum dryer for approximately 12 hours to obtain the acid-treated carbon material. An acid used in acid-treating may include nitric acid (e.g., 70 volume %).

A surface of the carbon material is hydrophobic and polysulfide generated during a battery reaction may not adhere to the surface of the carbon material. Therefore, the present invention makes the surface of the carbon material to be hydrophilic by performing the above acid-treatment so that the polysulfide is easily adhered to the surface of the carbon material and therefore, it prevents the polysulfide from losing from the cathode.

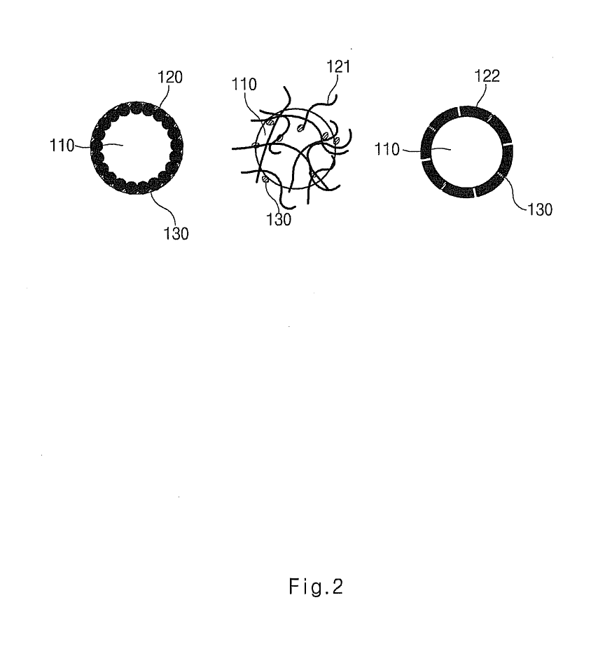

On the other hand, the polysulfide 130 generated in a battery reaction is confined in pores formed on a surface of the sulfur-carbon composite by a capillary force as shown in FIG. 2. An amount of the polysulfide confined in a surface of a carbon porous body by a capillary tube is proportional to a cosine value of a contact angle between the carbon material and the polysulfide and a surface energy difference between the polysulfide and an electrolyte solution and is inversely proportional to density of the polysulfide and a diameter of the pore. Herein, a technically controllable parameter is a pore diameter of the porous body and the contact angle between the polysulfide and the carbon material. This will be expressed by the following equation.

V∝γ∝cos θ/ρr

In the above equation, V represents a volume of the polysulfide included in the pore structure,

γ represents a difference of a surface energy between the polysulfide and an electrolyte solution,

θ is a contact angle between the carbon material and the polysulfide,

ρ represents density of the polysulfide, and

r represents a diameter of the pore.

The obtaining the sulfur-carbon composite by composition may use the principle that a particle having a large particle size forms an inner core and a particle having a small particle size forms an outer shell, when two particles which are not reacted with each other and are a small particle and a large particle having a particle size ten times larger than the small particle are mixed and shearing stress is applied to mixed two particles.

The applying the shearing stress may be performed by a planetary rotor type or a grinder type.

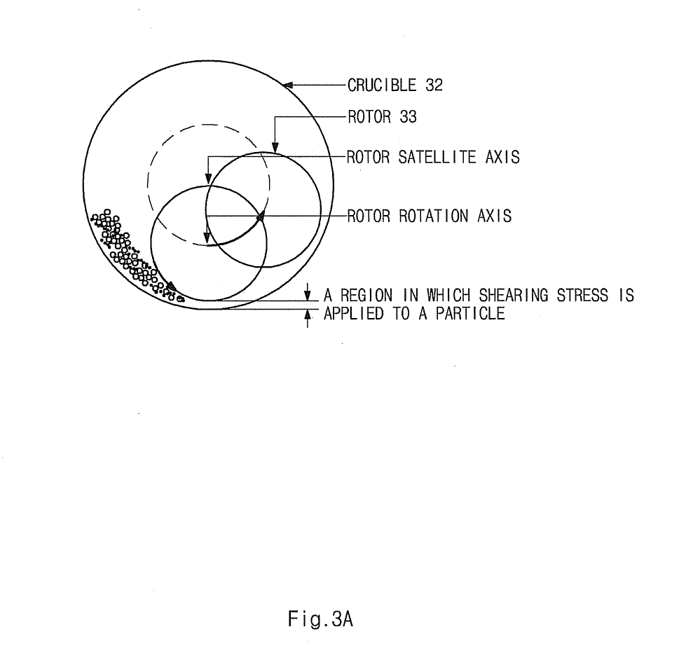

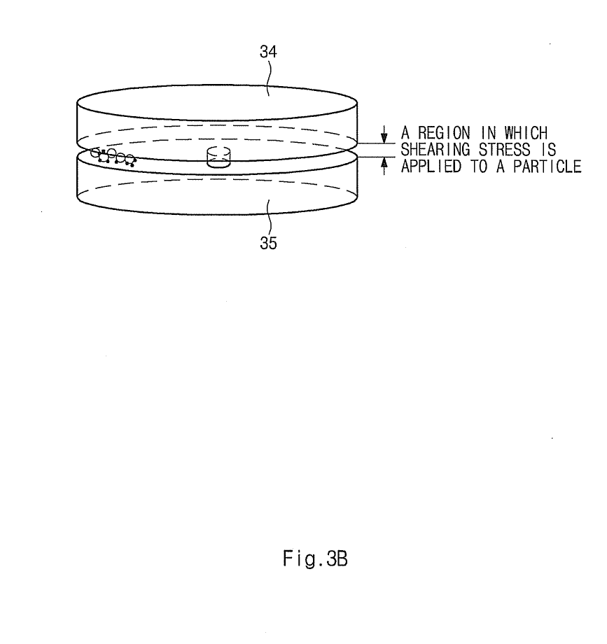

Referring to FIG. 3A, the planetary rotor method applies the shearing stress to the particles between two walls using an outer bowl (crucible 32) and an inner rotor 33 and at this time, the inner rotor makes a satellite motion around a center shaft of the outer bowl with self-rotation.

Referring to FIG. 3B, the grinder method uses a connection structure that two grinders (34 and 35) having flat surfaces are joined up and down with a small space. At this time, two grinders are rotated in the same direction, or in an opposite direction and the grinder method controls a rotation direction and speed of two grinders to adjust strength of shearing stress applied to the powder.

On the other hand, between the drying the sulfur compound and the acid-treated carbon material to obtain the sulfur compound powders and carbon material powders which moisture is removed from and the obtaining the sulfur-carbon composite by composition, the method may further include spherizing the sulfur compound powders.

The spherizing the sulfur compound powders may include rotating the sulfur compound powders using a spherizing apparatus at 300 to 500 rpm for 1 to 10 minutes.

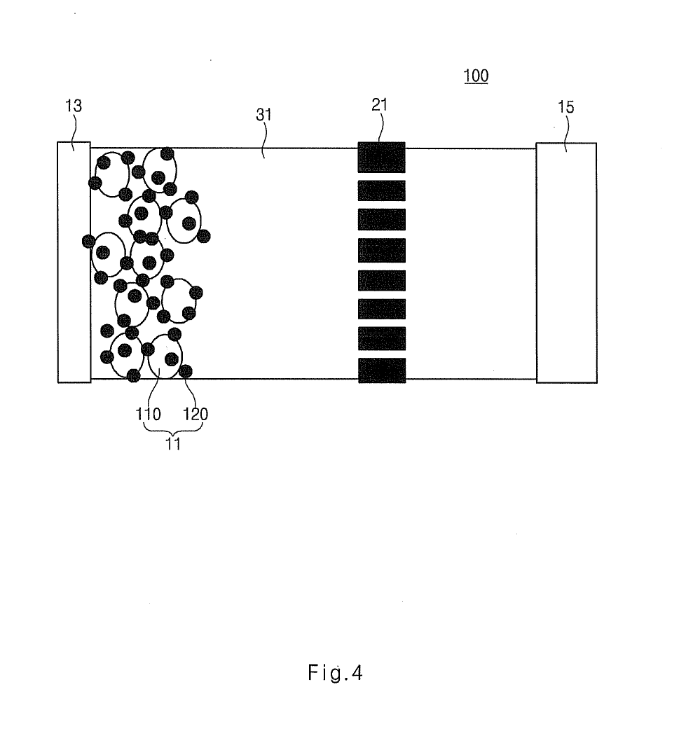

FIG. 4 is a schematic diagram of a lithium-sulfur battery 100 using a sulfur-carbon composite 11 as a cathode active material according to an embodiment of the present invention. In FIG. 4, reference numerals 13, 15, 21, and 31 represent a cathode, an anode, a separating film, and an electrolyte, respectively.

That is, the present invention uses the composite structure of the sulfur and the carbon material expressing the same function as the prior nano structure as a cathode active material and manufactures a composite during mixing the conductive material and the sulfur without using additional additive in the cathode via drying process, thereby improving performance of the lithium-sulfur battery.

When the sulfur-carbon composite is applied, cathode conductivity of the lithium-sulfur battery is increased to improve initial capacity close to theoretical capacity and minimize polysulfide lost in charging and discharging to increase a utilization rate of the sulfur. In addition, reaction between a lithium metal anode and the polysulfide is minimized to improve a life span and stability of the lithium-sulfur battery. Furthermore, the composite manufacturing process is a dry process and can apply the mixing process of the sulfur and the carbon material in the conventional battery fabrication process.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cathode active material for a metal-sulfur battery, comprising:
a sulfur-carbon composite composed of
a) a spherical sulfur compound particle; and
b) one or more carbon material particles.

2. The cathode active material according to claim 1, wherein the metal-sulfur battery includes a lithium-sulfur battery.

3. The cathode active material according to claim 1, wherein the carbon material particles have at least one of either a spherical shape or a fibrous shape.

4. The cathode active material according to claim 3, wherein the composite has a configuration selected from i) that the carbon material particles having the spherical or fibrous shape are coated and dispersed on a surface of the sulfur compound particle to be fixed thereto and ii) that the spherical carbon material particles and the fibrous carbon material particles are mixed to be fixed to the surface and the inside of the sulfur compound particle.

5. The cathode active material according to claim 4, wherein the fixing includes any one of adhering the carbon material particles on the surface of the sulfur compound particle, inserting the carbon material particles into the sulfur compound particle, fusing the carbon material particles and the carbon compound particle, or using a combination thereof.

6. The cathode active material according to claim 1, wherein the sulfur compound is a compound having sulfur-sulfur (S-S) bond.

7. The cathode active material according to claim 1, wherein carbon material is selected from the group consisting of carbon black, acetylene black, Ketjen black, and carbon fiber.

8. The cathode active material according to claim 1, wherein the spherical sulfur compound particle and the carbon material particles satisfy all the following conditions (1) to (3):
Rs>10*Rc, (1)
As*Ws>Ac*Wc, and (2)
Wc/(Ws+Wc)=0.2˜0.25; (3)
wherein Rs represents a particle diameter of the sulfur compound particle,
Rc represents a particle diameter of the carbon material particles,
As represents a BET surface area of the sulfur compound particle,
Ac represents a BET surface area of the carbon material particles,
Ws represents an amount used of the sulfur compound particle, and
Wc represents an amount used of the carbon material particles.

9. A method of preparing a cathode active material for a metal-sulfur battery, comprising;
preparing a sulfur compound and a carbon material satisfying all the following conditions (1) to (3):
Rs>10*Rc, (1)
As*Ws>Ac*Wc, and (2)
Wc/(Ws+Wc)=0.2˜0.25; (3)
wherein Rs represents a particle diameter of the sulfur compound,
Rc represents a particle diameter of the carbon material,
As represents a BET surface area of the sulfur compound,
Ac represents a BET surface area of the carbon material,
Ws represents an amount used of the sulfur compound, and
Wc represents an amount used of the carbon material;
acid-treating the carbon material;
drying the sulfur compound and the acid-treated carbon material to obtain sulfur compound powder and carbon material powder from which moisture is removed; and
mixing the sulfur compound powder and carbon material powder and compositing the mixed sulfur compound powder and carbon material powder by applying shearing stress to obtain a sulfur-carbon composite.

10. The method according to claim 9, wherein the acid-treating the carbon material comprises:
putting the carbon material in an acid solution;
stirring the acid solution at a temperature of 60 to 80° C. for 0.5 to 2 hours;
vacuum filtering the solution;
washing the filtered carbon material; and
drying the washed carbon material to obtain the acid-treated carbon material.

11. The method according to claim 10, wherein an acid used in the acid-treating comprises nitric acid.

12. The method according to claim 9, wherein the obtaining the sulfur-carbon composite by the compositing is performed by a planetary rotor type or a grinder type.

13. The method according to claim 9, further comprising spherizing the sulfur compound powder after drying the sulfur compound and the acid-treated carbon material and prior to obtaining the sulfur-carbon composite by the compositing.

14. The method according to 13, wherein the spherizing the sulfur compound powders comprises rotating the sulfur compound powder using a spherizing apparatus at 300 to 500 rpm for 1 to 10 minutes.

15. A system for preparing a cathode active material for a metal-sulfur battery, comprising;
means for preparing a sulfur compound and a carbon material satisfying all the following conditions (1) to (3):
Rs>10*Rc, (1)
As*Ws>Ac*Wc, and (2)
Wc/(Ws+Wc)=0.2˜0.25; (3)
wherein Rs represents a particle diameter of the sulfur compound,
Rc represents a particle diameter of the carbon material,
As represents a BET surface area of the sulfur compound,
Ac represents a BET surface area of the carbon material,
Ws represents an amount used of the sulfur compound, and
Wc represents an amount used of the carbon material;
means for acid-treating the carbon material;
means for drying the sulfur compound and the acid-treated carbon material to obtain sulfur compound powder and carbon material powder from which moisture is removed; and
means for mixing the sulfur compound powder and carbon material powder and compositing the mixed sulfur compound powder and carbon material powder by applying shearing stress to obtain a sulfur-carbon composite.
